(19) United States
(12) Patent Application Publication
(10) Pub. No.: US 2006/0245838 A1
(43) Pub. Date: Nov. 2, 2006

(54) ONE-PIECE END MILLING CUTTER

(76) Inventor: Hansruedi NAPFLIN, Beckenried (CH)

Correspondence Address: MARK D. SARALINO (GENERAL);RENNER, OTTO, BOISSELLE & SKLAR, LLP, 1621 EUCLID AVENUE, NINETEENTH FLOOR, CLEVELAND, OH, 44115-2191, US

(21) Appl. No.: 11/379,855

(22) Filed: Apr. 24, 2006

(30) Foreign Application Priority Data
Apr. 29, 2005 (DE) 10 2005 020513.5

(51) Int. Cl. B23C 3/12; B23C 3/28; B23C 5/10

(52) U.S. Cl. 409/132; 407/54; 409/138

(57) ABSTRACT

An end milling cutter includes a shank and a milling head with at least one cutter, whereas the cutter is arranged at the periphery of the milling head and is bent in the lengthwise direction of the milling head.

### TECHNICAL FIELD

The invention relates to an end milling cutter, which can be used particularly for the treatment of wood and synthetic material.

While processing the side faces and the edges of wood plates and synthetic material plates, as for example pressboard plates and medium density fibreboard plates (MDF), it must be paid attention to the fact that the edges are not damaged by the processing. Frequently, end milling cutters with cutters arranged on the periphery are used for edge processing. However, in conventional milling cutters the problem can appear that the edges are torn apart during the processing and that an improper sectional drawing originates if the edges of the milling cutter are no longer sufficiently sharp.

### BACKGROUND OF THE INVENTION

A groove milling cutter, which has a rotationally symmetrical shank and a milling part, is known from the registered utility patent DE 86 18 414.8 U1. The milling part has two bent cutting edges, which are arranged at the periphery of the milling part and which extend into the lengthwise direction of the milling part and which lie radially opposite to each other.

A milling cutter with a shank and a milling head with two bent cutting edges is also known from the printed paper JP 4141312 A, whereas the cutting edges are arranged at the periphery of the milling part and which extend into the lengthwise direction of the milling part and which lie radially opposite to each other.

### SUMMARY OF THE INVENTION

As a result a task of the invention is to specify an end milling cutter, with which it is ensured that the edges of the side face are not torn apart during the processing of a side face of a plate. During the processing the material should only be cut also in the edge area, but not torn out.

This task is solved by an end milling cutter with the characteristics of the claim 1.

The end milling cutter according to the invention comprises a shank and a milling head with at least one cutter, whereas the cutter is arranged at the periphery of the milling head and is bent.

Advantageous further developments of the invention result from the characteristics stated in the dependent patent claims.

That way it is provided in a further development of the end milling cutter according to the invention that the curvature of the cutter runs parallel to the longitudinal axis of the milling head in the centre area of the milling head.

In another embodiment of the end milling cutter according to the invention, the cutter is arranged in such a way that the entry angle at the beginning of the curvature and the exit angle at the end of the curvature are almost of the same size.

Advantageously the entry angle and/or the exit angle are between 10 and 30 degrees in the end milling cutter according to the invention. A milling cutter with these angles can be produced easily and also generates clean cut edges.

In addition it can be provided in the case of the end milling cutter according to the invention that the cutter extends across the length of the milling head. As a result the entire length of the milling head can be used for milling.

For solving the task it is also recommended that the effective cutting angle is constant across the length of the cutter.

It can also be provided that the effective cutting angle is between 0 and 25 degree.

In a further development of the end milling cutter according to the invention, the cutter is shaped in such a way that it is suitable for finishing.

Alternatively, in a further development of the end milling cutter according to the invention, the cutter can also be shaped in such a way that it is suitable for roughing.

Finally, the end milling cutter according to the invention can be used for milling edges of for example wood plates or synthetic material plates or laths. The end milling cutter according to the invention can also be used for milling grooves.

### BRIEF DESCRIPTION OF THE DRAWINGS

The invention will be further elucidated with reference to the four Figures described hereinafter.

FIG. 1 shows the end milling cutter according to the invention almost in the top view.

FIG. 2 shows the end milling cutter according to the invention in the side view.

FIG. 3 shows the end milling cutter according to the invention in a three-dimensional view.

FIG. 4 shows a second embodiment of the end milling cutter according to the invention in a three-dimensional view.

### DETAILED DESCRIPTION OF THE INVENTION

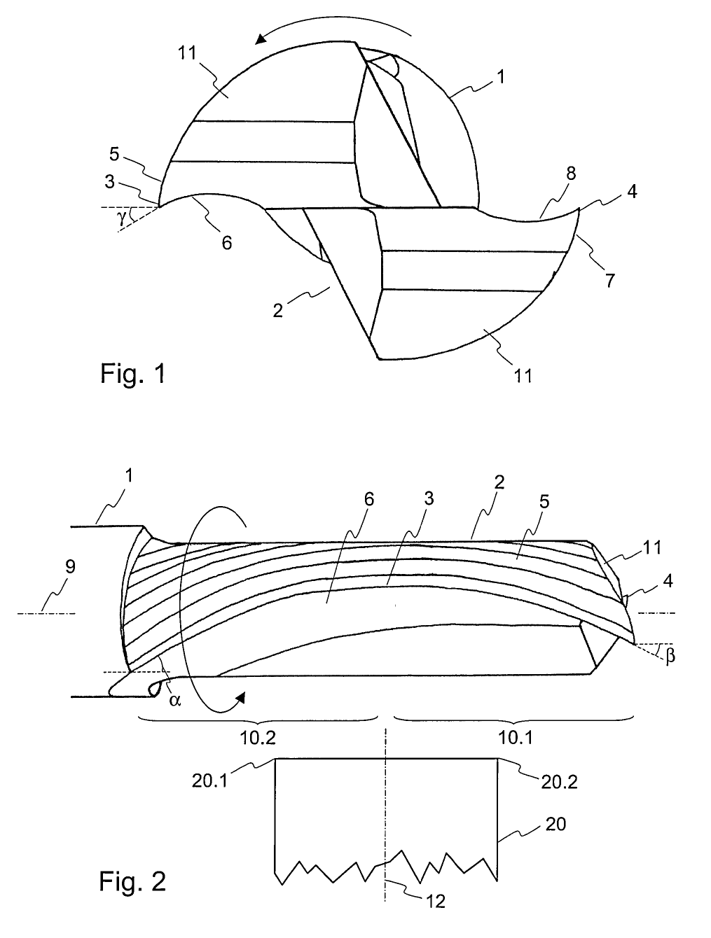

The end milling cutter according to the invention almost in the top view is shown in FIG. 1. The end milling cutter comprises a shank 1, with which it can be clamped into a milling machine. In addition, the end milling cutter according to the invention comprises a milling head 2, which has a first cutter 3 and a second cutter 4 in the embodiment shown in FIG. 1. The cutter 3 has a back surface 5 and a cutting surface 6, whereas the chips are removed over the cutting surface 6. The effective cutting angle γ, which is formed by the tangent at the end of the cutting surface 6 and by the radius line, is preferably in the range of 0 to 25 degree and is constant across the length of the cutter 3. The cutter 4 runs point-symmetrical to the cutter 3 and has a back surface 7 as well as a cutting surface 8. The same is valid for the effective cutting angle of the cutter 4 as for the effective cutting angle of the cutter 3. The front surface 11 of the milling head 2 is chamfered.

The end milling cutter according to the invention is shown in the side view in FIG. 2. The arrow marks the rotation direction of the milling cutter. The course of the cutters 3 and 4 is further explained in the following with the help of the cutter 3. The same applies equally to the cutter 4. The cutter 3 begins at the junction between the shank 1 and the milling head 2 and runs across the entire length of the milling head 2 up to its front end. As it can be identified from FIG. 2, the cutter 3 is bent in lengthwise direction and runs merely in the centre area of the milling head 2, therefore between the sections 10.1 and 10.2, parallel to the longitudinal axis 9 of the end milling cutter. At the junction between the shank 1 and the milling head 2, the cutter 3 encloses, with a line running parallel to the longitudinal axis 9, an angle α, which is named entry angle in the following. At the front end of the milling head 2, the cutter 3 encloses, with a line running parallel to the longitudinal axis 9, an angle β, which is named exit angle in the following. The entry angle α and the exit angle β can be of the same size, but must not be so.

The milling cutter has the tendency in the front sector 10.1 to pull the material to be processed axially in the direction of the milling cutter shank 1, what can also be called corkscrew effect. In contrast, in the rear sector 10.2, the milling cutter has the tendency to push the material to be processed axially away from itself.

Preferably the cutter 3 runs in the centre of the milling head 2, parallel to the longitudinal axis 9. As a result it is possible, in a simple way, to set the milling cutter opposite the work piece 20 to be processed in such a way that the milling cutter does not generates axial forces in the centre of the surface to be processed. Thereby it may be achieved that the milling cutter generates the same amount of axial forces on both the edges 20.1 and 20.2 of the work piece to be processed 20. The bent cutter 3 causes that the axial forces, which act upon the edges 20.1 and 20.2 to be processed of the work piece 20, act towards the centre of the working surface. An axial force, which points in the direction of the axis 12, acts on the edge 20.1 of the work piece 20 through the cutter 3. A force, which also points in the direction of axis 12, is applied on the edge 20.2 through the cutter 3. Thereby it is ensured that the edges 20.1 and 20.2 of the work piece 20 are not stressed by the forces acting outwards, i.e. away from the work piece and that they cannot fray. The end milling cutter according to the invention generates a clean sectional drawing, whereas the material is not torn apart in the edge sector or pushed away outwards, but it is cut.

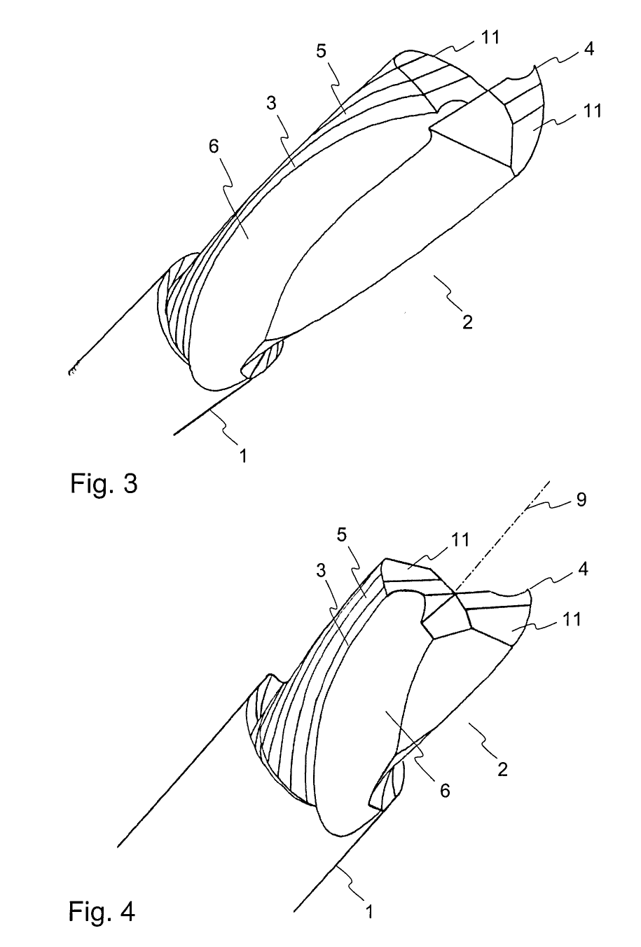

The end milling cutter according to the invention is shown in a three-dimensional view in FIG. 3. The front surface 11 of the end milling cutter can, as shown in the Figures, be chamfered.

The end milling cutter shown in FIG. 4 differs from the end milling cutter shown in FIG. 3 in this way that the exit angle β at the end of the milling head 2 is of approximately 0 degree. Consequently, the cutter 3 runs at the end of the milling head 2 parallel to the longitudinal axis 9 of the end milling cutter.

This embodiment—shown in FIG. 4—of the end milling cutter is particularly suitable for producing grooves. As soon as the milling cutter dips into the work piece, it pushes in axial direction the edges resulting during the milling in the direction of the work piece. This ensures that the material is not torn out in the sector of the edges or that it is not pushed away outwards, but that it is cut. Advantageously this principle works independently of the fact of how far the milling cutter penetrates into the work piece.

The cutters 3 and 4 are arranged at the periphery on the milling head 2 and can be shaped in such a way that they are suitable for roughing. The cutters 3 and 4 also have a slight waved structure for this purpose, what it is however not shown in the FIGS. 1 to 4. During the roughing the milling cutter can clear away a lot of material in a short time with high feed rate and deep cut. However, an even better quality of the surface can be achieved through finishing. In the milling cutter according to invention, the cutters 3 and 4 can therefore also be developed for finishing as shown in the Figures. In this case, the milling cutter with low feed rate and small cut can produce the final contour with a high upper surface quality. The more cutters are arranged at the periphery on the milling head 2, the finer and smoother the surface of the work piece will be.

The embodiments of end milling cutter shown in the FIGS. 1 to 4 were ground from a blank. The edges running essentially parallel to the cutters 3 and 4 on the back surface 5 and 7 have resulted from the grinding process.

The milling cutter according to the invention can be produced from hard metal and can be used especially for massive wood plates, plywood plates, veneered or laminated plates, wood core plywood, synthetic material plates, laths and components made from wood, synthetic material and aluminium. The milling cutter can be used when it is important to obtain a clean cut edge and smooth, burr-free edges.

The preceding description of the embodiments according to the present invention is used only for illustrative purposes and not for the purpose of restricting the invention. Different alterations and modifications are possible within the framework of the invention without leaving the scope of the invention and its equivalents.

### REFERENCE SIGNS

1 Shank
2 Milling head
3 First cutter
4 Second cutter
5 Back surface
6 Cutting surface
7 Back surface
8 Cutting surface
9 Longitudinal axis
10.1 Front sector of the milling head
10.2 Rear sector of the milling head
11 Front face
12 Axis
20 Work piece
20.1 Edge
20.2 Edge
α Entry angle
β Exit angle
γ Effective cutting angle or breast angle

1. A one-piece end milling cutter, comprising:
a shank; and
a milling head having at least a cutter, whereas the cutter is arranged at the periphery of the milling head and is bent, and whereas the curvature of the cutter runs parallel to the longitudinal axis of the milling head in the center area of the milling head.

2. An end milling cutter according to claim 1, wherein the cutter is arranged in such a way that the entry angle (α) at the beginning of the curvature and the exit angle (β) at the end of the curvature are approximately the same size.

3. An end milling cutter according to claim 1, wherein the entry angle (α) and/or the exit angle (β) are between 10 and 30 degrees.

4. An end milling cutter according to claim 1, wherein the cutter extends across the length of the milling head.

5. An end milling cutter according to claim 1, wherein the effective cutting angle (γ) is constant across the length of the cutter.

6. An end milling cutter according to claim 5, wherein the effective cutting angle (γ) is between 0 and 25 degrees.

7. An end milling cutter according to claim 1, wherein the cutter is shaped in such a way that it is suitable for finishing.

8. An end milling cutter according to claim 1, wherein the cutter is shaped in such a way that it is suitable for roughing.

9. A method of milling, comprising the steps of using the end milling cutter according to claim 1 for the milling of edges and groves.
